(19) United States
(12) Patent Application Publication
(10) Pub. No.: US 2026/0036869 A1
(43) Pub. Date: Feb. 5, 2026

(54) METHOD AND SYSTEM FOR CONSTRUCTION OF CRYSTALS FOR FREQUENCY CONVERSION

(71) Applicant: KLA Corporation, Milpitas, CA (US)

(72) Inventors: Kelly Mauser, Santa Clara, CA (US); Yung-Ho Alex Chuang, Cupertino, CA (US); John Fielden, Los Altos, CA (US); Xuefeng Liu, San Jose, CA (US); Baigang Zhang, San Jose, CA (US); Ding Ding, Claremont, CA (US)

(21) Appl. No.: 19/281,304

(22) Filed: Jul. 25, 2025

Related U.S. Application Data
(60) Provisional application No. 63/676,936, filed on Jul. 30, 2024.

(51) Int. Cl. G02F 1/355; G02F 1/35; H01S 3/109

(52) U.S. Cl. CPC G02F 1/3558; G02F 1/3501; G02F 1/3548; G02F 1/3551; H01S 3/109

(57) ABSTRACT

A method for constructing a periodically-poled nonlinear crystal may include implanting ions in a bulk crystal of strontium tetraborate (SBO) or lithium triborate (LBO) to generate a damaged layer at a predetermined depth, attaching a handle material to the surface of the bulk crystal, cleaving the bulk crystal at the damaged layer to generate a thin plate, and polishing the thin plate to a thickness suitable for quasi-phase-matching (QPM) to generate laser output light having wavelengths in the range of about 120-200 nm. The surfaces of thin plates generated in this way are optically contacted, and resulting stacks are diced and arranged to generate many-layered QPM crystals. Methods, inspection systems, lithography systems and cutting systems incorporating the laser assembly are also described.

### CROSS-REFERENCE TO RELATED APPLICATIONS

The present application claims the benefit of U.S. Provisional Application No. 63/676,936, filed on Jul. 30, 2024, which is incorporated herein by reference in the entirety.

### TECHNICAL FIELD

The present disclosure relates to the construction of periodically poled nonlinear crystals with several millimeters or more of clear aperture capable of generating light having DUV and VUV wavelengths, and more particularly to the construction of periodically poled nonlinear crystals capable of generating light in the range of approximately 120 nm to 200 nm and to systems that implement such nonlinear crystals. Systems incorporating the constructed nonlinear crystals disclosed herein may be configured to inspect samples, such as photomasks, reticles, and semiconductor wafers. In addition, systems incorporating the constructed nonlinear crystals disclosed herein may be configured as lithography systems for exposing patterns on substrates such as a semiconductor wafers, may be configured for cutting or drilling substrates, or may be configured for ablating or cutting biological tissue, such as in corrective eye surgery.

### BACKGROUND

As dimensions of semiconductor devices shrink, the size of the smallest particle or pattern defect that can cause a device to fail also shrinks. Hence, a need arises for detecting smaller particles and defects on patterned and unpatterned semiconductor wafers and reticles. The intensity of light scattered by particles smaller than the wavelength of that light generally scales as a high power of the dimensions of that particle. For example, the total scattered intensity of light from an isolated, small, spherical particle scales proportionally to the sixth power of the diameter of the sphere and inversely proportional to the fourth power of the wavelength. Because of the increased intensity of the scattered light, shorter wavelengths will generally provide better sensitivity for detecting small particles and defects than longer wavelengths.

Since the intensity of light scattered from small particles and defects is generally very low, high illumination intensity is required to produce a signal that can be detected in a very short time. Average light source power levels of 1 W or more may be required to produce such a signal. At these high average power levels, a high pulse repetition rate is desirable as the higher the repetition rate, the lower the energy per pulse and hence the lower the risk of damage to the system optics or the article being inspected. The illumination needs for inspection and metrology are often best met by continuous wave (CW) light sources. A CW light source has a constant power level, which avoids the peak power damage issues and allows for images or data to be acquired continuously. However, in many cases, mode-locked lasers (also called quasi-CW lasers) with repetition rates of about 50 MHz or higher can be useful because the high repetition rate means that the energy per pulse can be low enough to avoid damage for many metrology and inspection applications. The higher peak power of a mode locked laser as compared with a CW laser of the same average power level can allow more efficient and simpler frequency conversion.

Excimer lasers for generating vacuum ultraviolet (VUV) light are known in the art. Unfortunately, such lasers are not well suited to semiconductor inspection and metrology applications because of their low laser pulse repetition rates and their use of toxic and corrosive gases in their lasing media, which leads to high cost of ownership.

Various researchers have published results showing very low power levels (μW or mW) by frequency conversion of infrared or visible laser light into the VUV range. Such power levels are too low to be useful for semiconductor inspection or metrology. Furthermore, some of the materials used for the frequency conversion are not available in large, high-quality crystals.

Strontium tetraborate (SBO) represents a material with good VUV transmission, high damage threshold, and a reasonably high non-linear d₃₃ coefficient. The space group of SBO is Pnm2₁ and the point group is mm2. The natural crystallographic coordinates of SBO are a=4.4255 Å, b 10.709 Å, and c=4.2341 Å (Oseledchik, Y. S. et al., “New nonlinear optical crystals: strontium and lead tetraborates”, Optical Materials 4, 669-674 (1995)). It is noted that some authors label the crystal axes differently from Oseledchik et al. In this document, the convention of Oseledchik et al. is followed. The crystallographic coordinates in a rectangular frame of reference are X, Y, and Z, and X, Y, Z correspond to a, b, c. The optical coordinates are x, y, and z, and x, -y, z correspond to b, a, c respectively. The z optical coordinate corresponding to the n_{z} index of refraction is along the 2₁ symmetry axis of SBO. SBO has weak birefringence so critical and non-critical phase matching are not possible at VUV wavelengths. SBO has not been found to be ferroelectric, so periodic poling of crystals by applying an external electric field is not possible. The c-axis of SBO naturally switches during Czochralski growth. Studies have found it difficult to control the period of each layer during the growth process and have explored generation with randomly spaced layers. Random quasi-phase matching will be very low efficiency and will give unpredictable results that differ from crystal to crystal, which is undesirable in commercial lasers.

Lithium triborate (LBO) is a well-studied and commercially available nonlinear optical material with good transmission over wavelengths longer than about 160 nm, though its birefringence is too weak for critical and non-critical phase matching at VUV wavelengths. LBO belongs to the Pna2₁ space group and mm2 point group, indicating that d₃₁, d₃₂, d₃₃, d₂₄, and dis nonlinear coefficients may exist. For LBO, following the convention of Roberts, “Simplified characterization of uniaxial and biaxial nonlinear optical crystals: a plea for standardization of nomenclature and conventions”, IEEE Journal of Quantum Electronics, 28, 10 (1992), the natural crystallographic coordinates are a 7.3788 Å, b=8.4473 Å, and c=5.1395 Å. The crystallographic coordinates in a rectangular frame of reference are X, Y, and Z, and X, Y, Z correspond to a, b, c. The optical coordinates are x, y, and z, corresponding to b, c, a respectively. The y optical coordinate corresponding to the n_{y} index of refraction is along the 2₁ symmetry axis of LBO.

Ion slicing is a technique developed for the semiconductor industry in the 1990's to fabricate a thin monocrystalline layer on an insulator. Commonly, the thin crystalline layer is 10's to 1000's of nanometers of silicon on 10's to 1000's of nanometers of silicon dioxide on a silicon wafer. The final wafer is referred to as a silicon on insulator (SOI) wafer. Ion slicing cuts a layer from a bulk single-crystal grown via a method that produces minimal defects, and van der Waals bonds the single-crystal layer to the substrate.

In order to create a high-power VUV laser, it is necessary to create VUV/DUV-transmissive frequency conversion crystals constructed with large enough dimensions (approximately 5-10 mm clear aperture) to generate sufficient conversion efficiency (requiring approximately tens to thousands of poling periods) to produce high-power VUV/DUV light sources. However, unless the material is ferroelectric in the necessary dimension, a high-quality growth method for periodically poled VUV/DUV nonlinear bulk crystals does not currently exist.

Therefore, a need arises for a method of creating periodically-poled nonlinear crystals that overcomes the limitations of previous approaches as described above.

### SUMMARY

A method for creating a periodically poled nonlinear crystal is disclosed, in accordance with one or more embodiments of the present disclosure. In embodiments, the method includes implanting ions of a predetermined energy into a first nonlinear crystal at a uniform depth to generate a damaged or amorphous layer, wherein the nonlinear crystal comprises at least one of strontium tetraborate (SBO) or lithium triborate (LBO). In embodiments, the method includes adhering a handle comprising a solid material to the surface of the first nonlinear crystal. In embodiments, the method includes heating or chemically etching the first nonlinear crystal in order to cleave the first nonlinear crystal at the damaged or amorphous layer into a first thin plate attached to the handle and a larger crystal. In embodiments, the method includes polishing the first thin plate to a predetermined thickness to form a handle-plate (HP) stack.

An optical system is disclosed, in accordance with one or more embodiments of the present disclosure. In embodiments, the optical system includes an illumination source configured to generate illumination between 120 to 200 nm. In embodiments, the optical system includes an optical sub-system configured to direct the illumination from the illumination source onto a sample, wherein the illumination source comprises: a first fundamental laser configured to generate a fundamental laser beam having a corresponding fundamental frequency and a fundamental wavelength between 720 nm and 800 nm; and two or more frequency doubling stages, the two or more frequency doubling stages including at least an intermediate frequency doubling stage and a final frequency doubling stage, the intermediate frequency doubling stage is configured to receive the first fundamental frequency and generate a second harmonic light having a second harmonic frequency, the final frequency doubling stage is configured to generate laser output light from the second harmonic light, the final frequency doubling stage includes the nonlinear crystal configured to double a frequency of the second harmonic light, wherein the nonlinear crystal includes a plurality of crystal plates disposed in a stacked configuration such that each first crystal plate is adjacent to at least one second crystal plate, the plurality of crystal plates includes at least one of one or more strontium tetraborate (SBO) crystal plates or one or more lithium triborate (LBO) crystal plates, and wherein the plurality of crystal plates are cooperatively configured to form a periodic structure that achieves quasi-phase-matching (QPM) of the first fundamental frequency and the second harmonic frequency.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure

### BRIEF DESCRIPTION OF DRAWINGS

The numerous advantages of the disclosure may be better understood by those skilled in the art by reference to the accompanying figures.

FIG. 1 illustrates a simplified block diagram depicting a characterization system configured to inspect or measure a sample, in accordance with one or more embodiments of the present disclosure.

FIG. 2 illustrates a simplified block diagram depicting a laser assembly, in accordance with one or more embodiments of the present disclosure.

FIG. 3 illustrates a simplified diagram depicting a method for building a stack of two thin plates, in accordance with one or more embodiments of the present disclosure.

FIG. 4 illustrates a simplified diagram depicting a method for building a stack of two or more thin plates, in accordance with one or more embodiments of the present disclosure.

FIG. 5 illustrates a simplified diagram depicting a scalable method for building a stack of thin plates, in accordance with one or more embodiments of the present disclosure.

FIG. 6 illustrates a simplified diagram depicting a scalable method for building a stack of thin plates, in accordance with one or more embodiments of the present disclosure.

FIG. 7 illustrates a simplified diagram depicting a periodically poled SBO crystal built from thin plates, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to an improvement in creating nonlinear crystals of periodically poled SBO and LBO for semiconductor inspection and optical systems. Embodiments of the present disclosure are directed to the formation of periodically-poled nonlinear crystals that generate DUV radiation near a wavelength of 120-200 nm and avoids many or all of the disadvantages of previous crystals, and is suitable for use in systems configured for inspection of samples, configured for exposing a pattern into photoresist on a substrate, or configured for drilling, cutting or ablating materials including biological tissue.

Embodiments of the present disclosure are directed to a method of cutting thin layers of strontium tetraborate (SBO) (SrB₄O₇) or lithium triborate (LBO) (LiB₃O₅) single crystals and optically contacting the layers with alternating axis orientations appropriate for phase-matching conditions to create larger periodically poled SBO or LBO crystals for frequency conversion. In this disclosure, the surface of an SBO or LBO bulk single crystal in a specified crystal orientation may be cleaned and polished to sub-nanometer rms surface roughness. The surface may be implanted with ions (e.g., hydrogen (H⁺ or H₂⁺), helium, or oxygen) of a certain kinetic energy so that they are implanted at a specified depth (e.g., slightly deeper than the thickness necessary for phase matching the desired wavelengths in the desired propagation direction inside the crystal) in order to generate a damaged layer inside the crystal. A handle may be attached to the crystal surface, and the crystal is etched or annealed in order to cleave the crystal along the damaged layer, resulting in a thin crystal plate separating from the bulk crystal, this thin crystal plate being attached to the handle. This thin crystal plate may be polished to remove residual ion damaged material and be reduced to the thickness necessary for phase matching.

In one embodiment, the bulk single crystal may again be polished to sub-nanometer rms roughness and the entire process is repeated to form a second thin plate attached to a handle. These two thin plates are then optically contacted together (and so have opposite c-axis orientations) to make a handle-plate-plate-handle stack. This stack is diced in half perpendicular to the plane of the plate-plate contact. The top handle of one stack is removed, and the bottom handle of the other stack is removed, and then the exposed surfaces of the thin crystal plates from each stack are cleaned, and then are optically contacted with one another to create a four thin plate stack. This process is repeated to make stacks that are many plates thick, specifically 2 N plates thick where N is the number of dices. Preferably the plate thicknesses are between 0.15 and 100 μm thick.

In another embodiment, the surface of a second SBO or LBO bulk single crystal in a specified crystal orientation with the c-axis direction opposite to that of the first bulk single crystal, is cleaned and polished to sub-nanometer rms surface roughness. The surface is implanted with ions (e.g., hydrogen (H⁺ or H₂⁺), helium, or oxygen) of a certain kinetic energy so that they are implanted at a specified depth (e.g., slightly deeper than the thickness necessary for phase matching the desired wavelengths in the desired propagation direction inside the crystal) in order to generate a damaged layer inside the crystal. The surface of the thin crystal plate attached to the handle is optically bonded to the surface of the second bulk crystal. The second bulk crystal is etched or annealed in order to cleave the crystal along the damaged layer, resulting in a second thin crystal plate separating from the second bulk crystal, this second thin crystal plate being optically bonded to the first thin crystal plate and having an opposite c-axis direction. This second thin crystal plate may be polished to remove residual ion damaged material and be reduced to the thickness necessary for phase matching. The surface of the first bulk single crystal is again polished, and the process of cleaving off another thin crystal plate is repeated. Repeating this process, a stack of thin crystal plates with alternating c-crystal axis can be constructed. Preferably, the plate thicknesses are between 0.15 and 40 μm thick. In certain embodiments, a handle can be attached to the bottom of the stack of thin crystal plates, and the stack can be diced perpendicular to the planes of the optical bonds of the thin crystal plates. The top or bottom handles of the diced stacks can be removed, the crystal plate surfaces cleaned, and the cleaned surfaces optically bonded to one another. This process of dicing, removing handles, cleaning, and bonding can be done repeatedly to produce a stack many layers thick (e.g. hundreds or thousands of layers).

Having constructed the larger crystal from the periodically poled optically contacted slabs, the larger crystal is diced and stacked using Van der Waals forces or optical contacting to adhere the layers in order to produce a crystal with substantially more alternating crystal poles than the original crystal.

A portion of or the entire larger crystal can also be used as a seed for larger crystal growths, for example, as described in U.S. patent application Ser. No. 18/588,822, entitled “System and method for growth of quasi-phase matched strontium tetraborate and lithium triborate crystals for frequency conversion”, which was filed on Feb. 27, 2024, which is incorporated by reference herein in the entirety. For example, a nonlinear crystal may be grown; using, as a seed, the periodically poled crystal created using the methodology described herein. The method growing a nonlinear crystal from a seed of a periodically poled crystal is described in U.S. patent application Ser. No. 18/588,822, which is incorporated by reference previously herein.

These constructed nonlinear crystals generate light having a DUV wavelength (such as a wavelength between about 120 nm and about 200 nm for SBO and 160 nm and about 200 nm for LBO) at high power while avoiding the above-mentioned problems and disadvantages associated with prior art approaches. Note that in the following description, where a wavelength is mentioned without qualification, that wavelength may be assumed to be the wavelength in vacuum.

An optical system is disclosed, in accordance with one or more embodiments of the present disclosure. In embodiments, the optical system includes an illumination source configured to generate illumination having a wavelength between 120 nm and 200 nm. In embodiments, the optical system includes an optical sub-system configured to direct the illumination from the illumination source onto a sample. In embodiments, the illumination source includes a first fundamental laser configured to generate a fundamental laser beam having a corresponding fundamental frequency and a fundamental wavelength between 720 nm and 800 nm or between 1030 and 1075 nm. In embodiments, the illumination source includes two or more frequency conversion stages, the two or more frequency conversion stages including at least an intermediate frequency conversion stage and a final frequency conversion stage, where the intermediate frequency conversion stage is configured to receive the first fundamental frequency and generate a second frequency light, where the final frequency conversion stage is configured to generate laser output light from the second frequency light, where the final frequency conversion stage includes the nonlinear crystal configured to double a frequency of the second frequency light, where the nonlinear crystal includes a plurality of crystal plates disposed in a stacked configuration such that each first SBO crystal plate is adjacent to at least one second crystal plate, where the plurality of crystal plates includes at least one of one or more strontium tetraborate (SBO) crystal plates or one or more lithium triborate (LBO) crystal plates, and where the plurality of crystal plates are cooperatively configured to form a periodic structure that achieves quasi-phase-matching (QPM) of the second frequency.

A laser system is disclosed, in accordance with one or more embodiments of the present disclosure. In embodiments, the laser system includes a first fundamental laser configured to generate a fundamental laser beam having a corresponding fundamental frequency and a fundamental wavelength between 720 nm and 800 nm or between 1030 and 1075 nm. In embodiments, the illumination source includes two or more frequency conversion stages, the two or more frequency conversion stages including at least an intermediate frequency conversion stage and a final frequency conversion stage, where the intermediate frequency conversion stage is configured to receive the first fundamental frequency and generate a second frequency light, where the final frequency conversion stage is configured to generate laser output light from the second frequency light, where the final frequency conversion stage includes the nonlinear crystal configured to double a frequency of the second frequency light, where the nonlinear crystal includes a plurality of crystal plates disposed in a stacked configuration such that each first SBO crystal plate is adjacent to at least one second crystal plate, where the plurality of crystal plates includes at least one of one or more strontium tetraborate (SBO) crystal plates or one or more lithium triborate (LBO) crystal plates, and where the plurality of crystal plates are cooperatively configured to form a periodic structure that achieves quasi-phase-matching (QPM) of the second frequency.

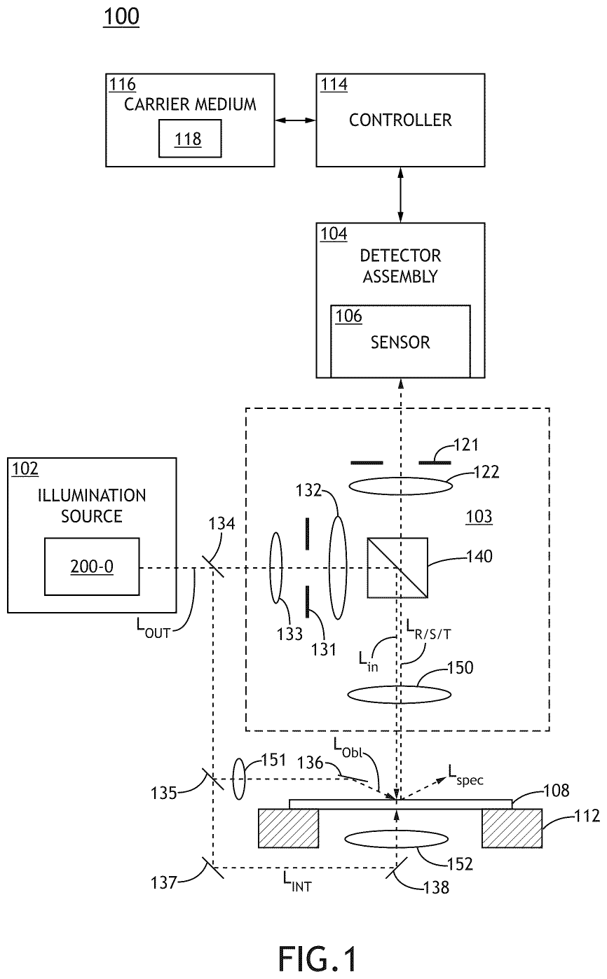

FIG. 1 illustrates a simplified block diagram of an optical system 100, in accordance with one or more embodiments of the present disclosure. The optical system 100 may be configured as an inspection system or a metrology system for inspecting a sample 108 and/or acquiring optical metrology measurements from the sample 108. The optical system 100 may include a semiconductor fabrication system. For example, the optical system may include a fabrication system that may be configured to cut, drill or ablate material from sample 108, or to expose a pattern onto photoresist on sample 108.

The sample 108 may include any sample known in the art such as, but not limited to, a wafer, reticle, photomask, or the like. In embodiments, the sample 108 may be disposed on a stage assembly 112 to facilitate movement of the sample 108. The stage assembly 112 may include any stage assembly known in the art including, but not limited to, an X-Y stage, an R-8 stage, and the like. In embodiments, the stage assembly 112 is capable of adjusting the height of the sample 108 during inspection to maintain focus on the sample 108. In embodiments, a lens such as objective lens 150 may be moved up and down during inspection to maintain focus on the sample 108.

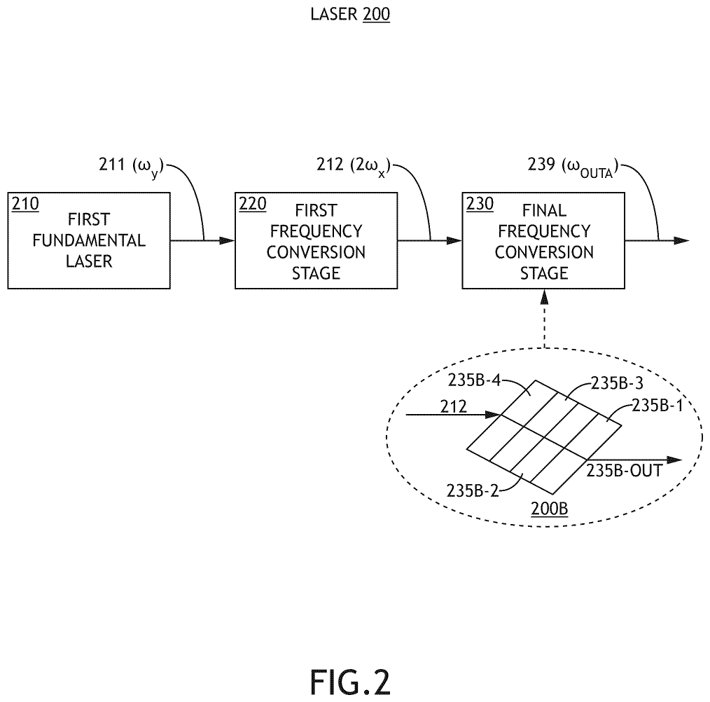

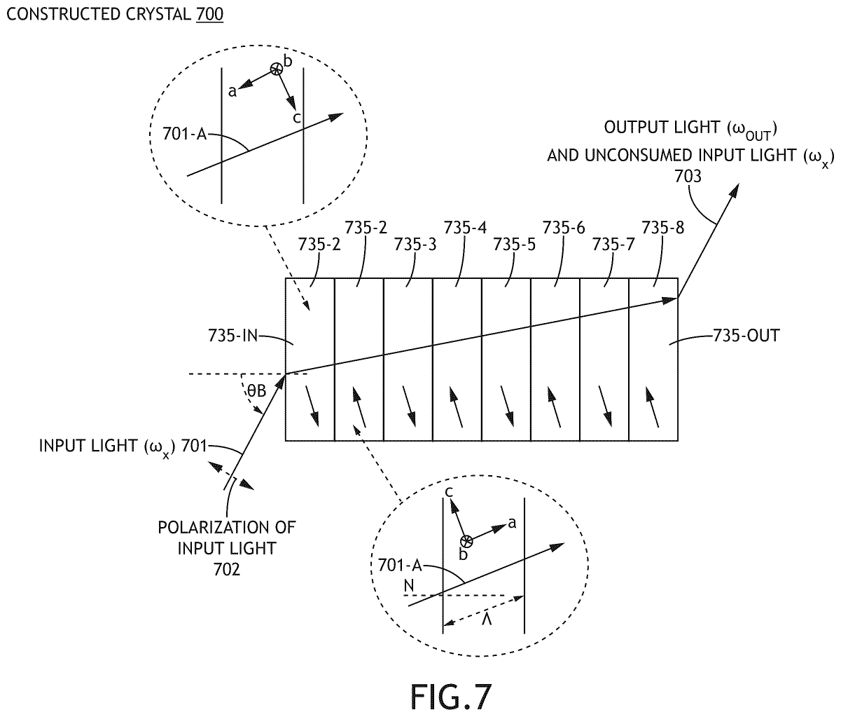

In embodiments, the optical system 100 includes an illumination source 102 that incorporates a laser 200-0 that generates output light Lout having an output frequency Wout with a corresponding wavelength in a range between approximately 120 nm and approximately 200 nm. Details of an exemplary laser 200-0 can be found in the description of FIGS. 2 and 7. Laser 200-0 incorporates at least one of an SBO and an LBO quasi-phase matched crystal as grown using the methods described herein. Illumination source 102 may include additional light sources such as a laser operating at a longer or shorter wavelength or a broadband light source.

In embodiments, the optical system 100 includes one or more optical components such as, but not limited to, beam splitters, mirrors, lenses, apertures and waveplates that are configured to condition and direct light Lout to sample 108. The optical components may be configured to illuminate an area, a line, or a spot on sample 108. In embodiments beam splitter or mirror 134, mirrors 137 and 138 and lens 152 are configured to illuminate sample 108 from below so as to enable inspection or measurement of sample 108 by transmitting light L_{INT} through the sample. In embodiments, beam splitters or mirrors 134 and 135, mirror 136 and lens 151 are configured to illuminate sample 108 with light at an oblique angle of incidence L_{obl}, for example at an angle of incidence greater than 60° relative to a normal to the sample surface. In this embodiment, the specularly reflected light L_{spec} may be blocked or discarded rather than collected. In embodiments, optics 103 are collectively configured to direct illumination light L_{IN} to the top surface of sample 108.

When the sample 108 is illuminated in one or more of the above-described modes, the optics 103 are also configured to collect light LR/S/T reflected, scattered, diffracted, transmitted and/or emitted from the sample 108 and direct and focus the light LR/S/T to sensor 106 of a detector assembly 104. It is noted herein that sensor 106 and the detector assembly 104 may include any sensor 106 known in the art. For example, the sensor 106 may include, but is not limited to, a charge-coupled device (CCD) detector, a complementary metal oxide semiconductor (CMOS) detector, a time-delay integration (TDI) detector, a photomultiplier tube (PMT), an avalanche photodiode (APD), a line sensor, an electron-bombarded line sensor, or the like. The detector assembly 104 may be communicatively coupled to a controller 114.

The controller 114 may be configured to store and/or analyze data from detector assembly 104 under control of program instructions 118 stored on carrier medium 116. The controller 114 may be further configured to control other elements of optical system 100 such as stage 112, illumination source 102 and optics 103.

In embodiments, the optics 103 includes an illumination tube lens 132. The illumination tube lens 132 may be configured to image an illumination pupil aperture 131 to a pupil within an objective lens 150. For example, the illumination tube lens 132 may be configured such that the illumination pupil aperture 131 and the pupil within the objective lens 150 are conjugate to one another. In embodiments, the illumination pupil aperture 131 may be configurable by switching different apertures into the location of illumination pupil aperture 131. In embodiments, the illumination pupil aperture 131 may be configurable by adjusting a diameter or shape of the opening of the illumination pupil aperture 131. In this regard, the sample 108 may be illuminated by different ranges of angles depending on the characterization (e.g., measurement or inspection) being performed under control of the controller 114. The illumination pupil aperture 131 may also include a polarizing element to control the polarization state of the illumination light L_{IN}.

In embodiments, the one or more optical elements 103 include a collection tube lens 122. For example, the collection tube lens 122 may be configured to image the pupil within the objective lens 150 to a collection pupil aperture 121. For instance, the collection tube lens 122 may be configured such that the collection pupil aperture 121 and the pupil within the objective lens 150 are conjugate to one another. In embodiments, the collection pupil aperture 121 may be configurable by switching different apertures into the location of collection pupil aperture 121. In embodiments, the collection pupil aperture 121 may be configurable by adjusting a diameter or shape of the opening of collection pupil aperture 121. In this regard, different ranges of angles of illumination reflected or scattered from the sample 108 may be directed to detector assembly 104 under control of the controller 114. The collection pupil aperture 121 may also include a polarizing element so that a specific polarization of light LR/S/T can be selected for transmission to sensor 106. In embodiments, the illumination pupil aperture 131 and/or the collection pupil aperture 121 may include a programmable aperture.

The various optical elements and operating modes depicted in FIG. 1 are merely to illustrate how laser 200-0 may be used in inspection system 100 and are not intended to limit the scope of the present disclosure. A practical optical system 100 may implement a subset or a superset of the modes and optics depicted in FIG. 1. Additional optical elements and subsystems may be incorporated as needed for a specific application.

FIG. 2 is a simplified block diagram depicting a laser assembly 200 configured to generate a wavelength in the range of approximately 120 nm to approximately 200 nm (e.g., approximately 193 nm) according to an embodiment of the present disclosure.

In embodiments, the laser assembly 200 includes a first fundamental laser 210 and two frequency doubling (conversion) stages (i.e., one intermediate frequency doubling stage 220, and a final frequency doubling stage 230) that are cooperatively configured to generate laser output light 239 having a wavelength in the range of approximately 120 nm to approximately 200 nm. The first fundamental laser 210 is configured to generate fundamental light 211 having a first fundamental wavelength in the range of approximately 720 nm to approximately 800 nm and a corresponding first fundamental frequency ω_{y}. The first frequency doubling stage 220 receives the first fundamental light 211 and generates second harmonic light 212 with a second harmonic frequency ωₓ equal to twice the first fundamental frequency ω_{y}. The final (second) frequency doubling stage 230 receives the second harmonic light (intermediate frequency light) 212 and generates the laser output light 239 with an output frequency ωₒᵤₜ that is equal to four times the first fundamental frequency ω_{y}.

Referring to FIG. 2, the first fundamental laser 210 is configured using any suitable technique to generate the first fundamental light 211 (“fundamental”) at the first fundamental frequency ω_{y}. In embodiments, the first fundamental laser 210 is configured such that the first fundamental light 211 is generated at a first fundamental frequency ω_{y} corresponding to a wavelength between approximately 720 nm and approximately 800 nm (such as a wavelength of approximately 774 nm). In embodiments, the first fundamental laser 210 is implemented using a titanium-sapphire (Ti-sapphire) lasing medium. Suitable fundamental lasers operating at wavelengths near 800 nm are commercially available from Spectra-Physics and other manufacturers. In order to generate sufficient light at a wavelength of approximately 193 nm for inspecting semiconductor wafers, reticles or photomasks, it is contemplated herein that the first fundamental laser 210 should generate tens or hundreds of Watts of fundamental light 211. Other applications may not require so much power or may need more power. Depending on the pulse width and repetition rate requirements for laser 200-0, the first fundamental laser may be configured as a Q-switched laser, a mode-locked laser or a CW laser.

The first frequency conversion (doubling) stage 220 may be configured to generate second harmonic light 212 from the first fundamental light 211. In embodiments, the first frequency conversion (doubling) stage 220 incorporates a lithium triborate (LBO) nonlinear crystal configured for critical phase matching of the first fundamental frequency and the second harmonic frequency. The first frequency conversion (doubling) stage 220 may include other components as necessary, such as a prism for separating the second harmonic light 212 from unconsumed fundamental light. The first frequency conversion (doubling) stage 220 may include a cavity resonant at the first fundamental frequency to increase the conversion efficiency.

The final frequency conversion (doubling) stage 230 may be configured to generate laser output light 239 from the second harmonic light 212. The final frequency conversion (doubling) stage 230 may incorporate nonlinear crystal 200B configured to double the frequency of the second harmonic light 212, and to output light 235B-OUT that includes light at the frequency of the laser output light 239 and unconsumed second harmonic light. The nonlinear crystal 200B may include a stack of SBO or LBO plates. It is noted herein that for purposes of illustration, FIG. 2 depicts four such plates, 235B-1, 235B-2, 235B-3 and 235B-4 stacked one on the other. However, it is noted herein that in a practical embodiment, there may be tens or hundreds or thousands of stacked plates. FIG. 2 depicts the plates as touching one another. The thickness of each plate is chosen to enable quasi-phase matching for doubling the frequency of the second harmonic light 212. Adjacent plates (such as plates 235B-1 and 235B-2) have their crystal c axes oriented in opposite directions relative to one another. These and other important aspects of the nonlinear crystal are described in detail below in relation to FIG. 7.

The final frequency conversion (doubling) stage 230 may include other optical components as necessary, such as a prism for separating the laser output light 239 from unconsumed fundamental and second harmonic light. The final frequency conversion (doubling) stage 230 may include a cavity to recirculate the second harmonic frequency to increase the conversion efficiency.

In embodiments, a single cavity may include both a first frequency conversion stage 220 and a final frequency conversion stage 230. In embodiments, the first fundamental laser 210 includes a laser with output frequency 211 of approximately 1000 nm, such as 1064 nm or 1030 nm. In embodiments, the first frequency conversion stage 220 includes sum-frequency generation, difference-frequency generation, optical parametric oscillation, or optical parametric amplification stages. In embodiments, the final frequency conversion stage 230 includes a sum-frequency generation stage with frequency conversion crystal 200B, as described further in the description of FIG. 7.

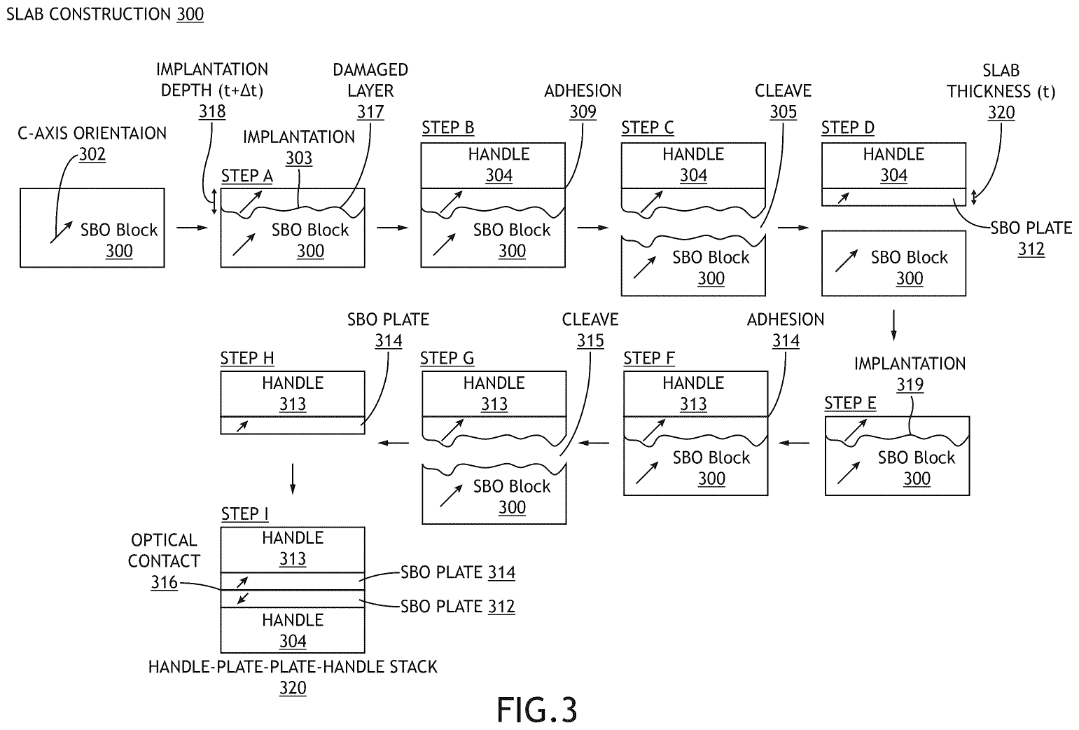

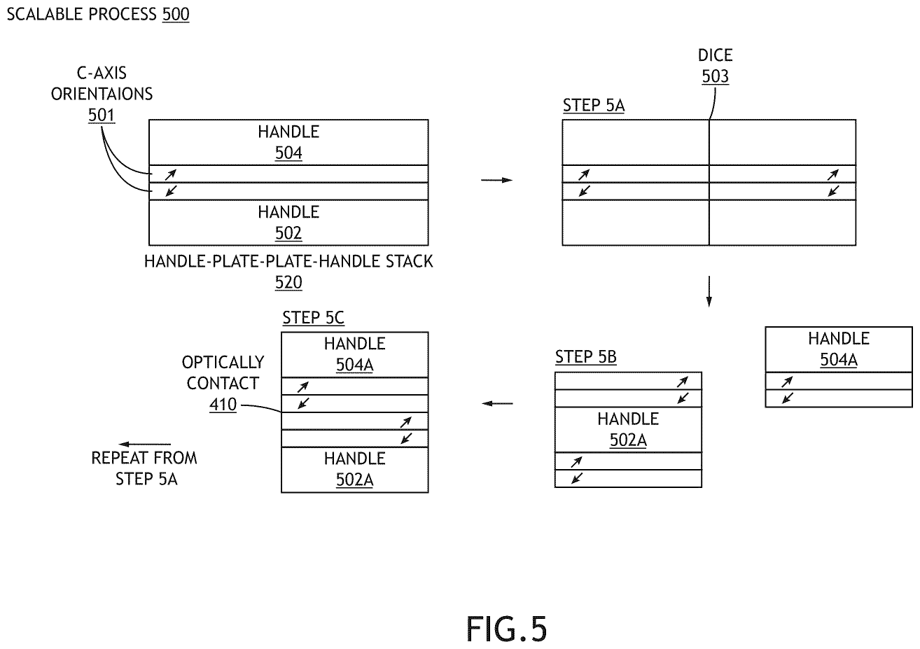

FIG. 3 illustrates a simplified method for fabricating a stack of two SBO thin plates 314 and 312 of alternating c-axis orientation. The SBO single crystal source block 300 can be grown with any high-quality crystal growth method, such as the top-seeded Kyropoulos method, Czochralski method, hydrothermal method, or another melt, flux, or pulling method. SBO block 300 has c-axis orientation 302 appropriate for quasi-phase matching the involved wavelengths propagating at the desired orientation through the final constructed crystal, detailed in the description accompanying FIG. 7. Referring to Step A of FIG. 3, ion implantation 303 is performed with hydrogen (H⁺ or H₂⁺), helium, oxygen, argon, or other ions with implantation energy between about 30 keV and 5 MeV in order to generate a damaged layer 317 at an average depth 318 of t+Δt, where t is the thickness of the thin plate needed for quasi-phase matching of the SBO (detailed in the description accompanying FIG. 7), and Δt is an additional thickness to act as a buffer layer, which will be later polished away and will be discussed below. The fluence of ions may be between 0.5×10¹⁶ and 1×10¹⁸ atoms/cm². Damaged layer 317 may include one or multiple gaseous bubbles, amorphous layers, layers with different thermal expansion coefficients than the bulk, and damaged crystal lattice containing a high density of defects or vacancies. The thickness of damaged layer 317 is determined by the stopping region (straggle range) of ions, which depends on the ion type, dose or fluence, energy, and material, and may be tens to hundreds of nm thick. Stopping and straggle ranges of ions can be calculated with software such as SRIM. Referring to Step B of FIG. 3, handle 304 is adhered 309 to the surface of the SBO block 300. Handle 304 may comprise SBO, calcium fluoride, magnesium fluoride, lithium fluoride, silicon dioxide, silicon, sapphire, an organic polymer, or another rigid material. The adhesion 309 between handle 304 and SBO block 300 may comprise an adhesive such as an epoxy, a direct contact as in the case of an organic handle 304, or an optical contact bond or Van der Waals contact. For example, adhesion 309 consisting of an optical contact bond can be performed by polishing both surfaces to 1 nm rms surface roughness or less, cleaning the surfaces, and then pressing the surfaces together for multiple hours or days, heating both surfaces while they are pressed together, activating/cleaning both surfaces with a plasma before pressing together and/or heating, activating both surfaces by flowing a reactive gas such as ammonia or silane over the surfaces before pressing together and/or heating, or activating the surface with another chemical method before pressing together and/or heating. The temperature and rate of heating should be less than that needed to cleave the surface at the damaged layer (e.g., less than the effective activation energy and time of cleaving). Optical contact bonding may take place in a vacuum chamber or in a clean, inert atmosphere (e.g., high purity Ar or N₂ gas) to aid in cleanliness of the surfaces. Referring to Step C of FIG. 3, the SBO block 300 may be cleaved at the damaged layer 317 using a method including rapid heating or etching. The time and temperature necessary to cleave may be approximated by the effective activation energy Eₐ∝k_{b}T ln(t_{c}), where k_{b} is the Boltzmann constant and t_{c} is the time needed for cleaving at temperature T. The energy needed to initiate cleaving, may be approximately equal to the bond energy (or less under a high ion fluence). Before or after the cleaving Step C, the handle and thin layer may be annealed at a temperature less than the cleaving temperature to reduce defects and thereby relieve strain in the thin layer caused by the ion implantation step. Referring to Step D of FIG. 3, the thin layer of SBO adhered to handle 304 is polished to thickness t 320 to form SBO plate 312 with less than 1 nm rms surface roughness. The surface of SBO block 300 is polished to less than 1 nm rms surface roughness. Referring to Steps E-G of FIG. 3, the process of Steps A-D are repeated to generate handle 313 adhered to SBO plate 314 of thickness t. Referring to Step I of FIG. 3, handle 304 and SBO plate 312 are inverted such that the c-crystal axis of SBO plate 312 and 314 are inverted with regards to each other. The surfaces of SBO plate 314 and SBO plate 312 and then optically contact bonded 316 to one another using one of the above-mentioned techniques, or another technique not listed. An SBO crystal with many more plates can be generated from the handle-plate-plate stack in Step I, using the method outlined in FIG. 5. A similar process may be used with a high-quality single-crystal LBO block to create a stack of thin plates.

In embodiments, referring to FIG. 3, Steps E-H may be substituted by dicing handle 304 attached to SBO thin plate 312 after Step D is completed, perpendicular to the polished surface of SBO plate 312. The diced piece would become handle 313 and SBO plate 314 and Step I could be completed. The benefit of this embodiment is the need for only one ion implantation, adhesion, cleaving, and polishing step, in addition to better thickness uniformity of both plates 314 and 312 as they originate from the same process steps.

In embodiments, different methods may be used to mitigate cracking in the thin SBO plate caused by strain and stress induced by a mismatch in thermal expansion coefficient of the handle material or by defects generation from ion implantation. These methods may include using SBO or sapphire, for example, as a handle to more closely match the thermal expansion coefficients. Another method may include an ion implantation step on the back side of the SBO bulk crystal to match the stress and strain on either side of the crystal and prevent bowing and cracking. To enhance optical bonding strength, a thin (approximately 1 nm) layer of silicon dioxide may be deposited, or a thicker layer may be deposited via plasma enhanced chemical vapor deposition under conditions to produce the appropriate stress and strain. After necessary annealing or polishing, this silicon dioxide layer can then be optically contact bonded to a handle which would not otherwise readily optically bond to SBO, or which needs heating in order to bond to SBO which could cause damage or cracking.

In embodiments, the method depicted in FIG. 3 may be applied to generate thin plates of LBO with the appropriate choice of orientation of the crystal axis.

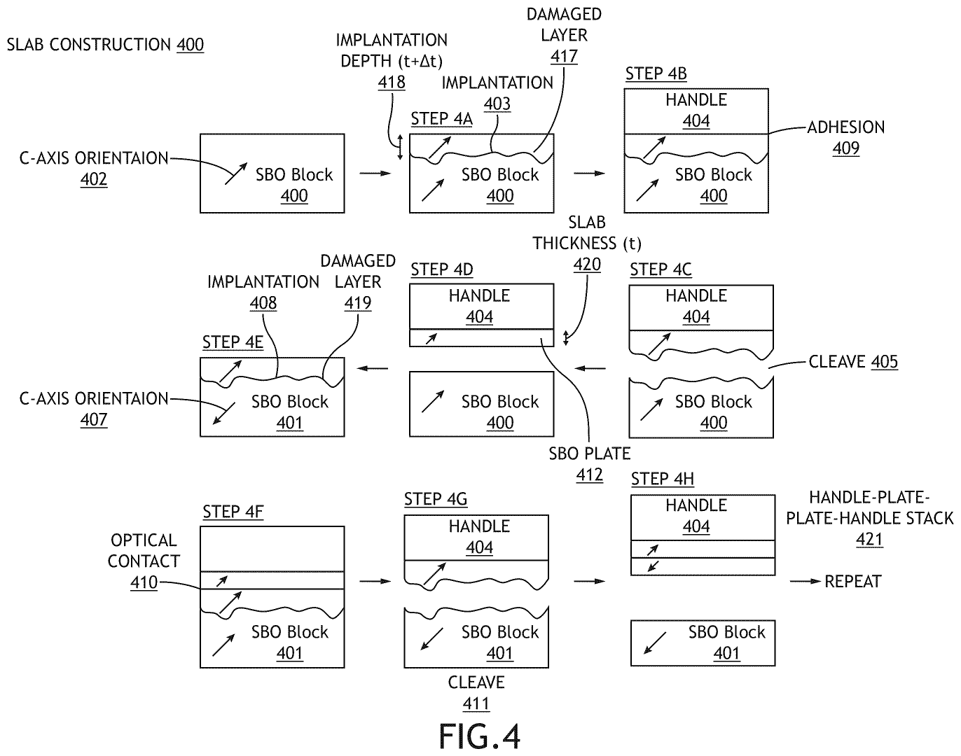

FIG. 4 illustrates a simplified method for fabricating a stack of multiple SBO thin plates of alternating c-axis orientation. The SBO single crystal source block 400 can be grown with any high-quality crystal growth method, such as the top seeded Kyropoulos method, Czochralski method, hydrothermal method, or another melt, flux, or pulling method. SBO block 400 has c-axis orientation 402 appropriate for quasi-phase matching the involved wavelengths propagating at the desired orientation through the final constructed crystal, detailed in the description accompanying FIG. 7. Referring to Step 4A of FIG. 4, ion implantation 403 is performed with hydrogen (H⁺ or H₂⁺), helium, oxygen, or other ions with implantation energy between about 30 keV and 5 MeV in order to generate a damaged layer 417 at an average depth 418 of t+Δt, where t is the thickness of the thin plate needed for quasi-phase matching of the SBO (detailed in the description accompanying FIG. 7), and Δt is an additional thickness to act as a buffer layer, which will be later polished away and will be discussed below. The fluence of ions may be between 0.5×10¹⁶ and 1×10¹⁸ atoms/cm². Damaged layer 417 may include one or multiple gaseous bubbles, amorphous layers, layers with different thermal expansion coefficients than the bulk, and damaged crystal lattice containing a high density of defects or vacancies. The thickness of damaged layer 417 is determined by the stopping region (straggle range) of ions, which depends on the ion type, dose or fluence, energy, and material, and may be tens to hundreds of nanometers thick. Stopping and straggle ranges of ions can be calculated with software such as SRIM. Referring to Step 4B of FIG. 4, handle 404 is adhered 409 to the surface of the SBO block 400. Handle 404 may comprise SBO calcium fluoride, magnesium fluoride, lithium fluoride, silicon dioxide, silicon, sapphire, an organic polymer, or another rigid material. The adhesion 409 between handle 404 and SBO block 400 may comprise an adhesive such as an epoxy, a direct contact as in the case of an organic handle 404, or an optical contact bonding or Van der Waals contact. For example, adhesion 409 consisting of an optical contact bond can be performed by polishing both surfaces to 1 nm rms surface roughness or less, cleaning the surfaces, and then pressing the surfaces together for multiple hours or days, heating both surfaces while they are pressed together, activating/cleaning both surfaces with a plasma before pressing together and/or heating, activating both surfaces by flowing a reactive gas such as ammonia or silane over the surfaces before pressing together and/or heating, or activating the surface with another chemical method before pressing together and/or heating. The temperature and rate of heating should be less than that needed to cleave the surface at the damaged layer, i.e. less than the effective activation energy and time of cleaving. Optical contact bonding may take place in a vacuum chamber to aid in cleanliness of the surfaces. Heating may also be performed to repair defects in the crystal lattice caused by ions far from the damaged layer. Referring to Step 4C of FIG. 4, the SBO block 400 is cleaved at the damaged layer 417 using a method comprising of heating or etching. The time and temperature necessary to cleave may be approximated by the effective activation energy Eₐ∝k_{b}T ln(t_{c}). The energy needed to initiate cleaving may be approximately equal to the bond energy, or less under a high ion fluence. Before or after the cleaving Step 4C, the handle and thin layer may be annealed at a temperature less than the cleaving temperature to reduce defects and thereby relieve strain in the thin layer caused by the ion implantation step. Referring to Step 4D of FIG. 4, the thin layer of SBO adhered to handle 404 is polished to thickness t 420 to form SBO plate 412 with less than 1 nm rms surface roughness. The surface of SBO block 400 is polished to less than 1 nm rms surface roughness.

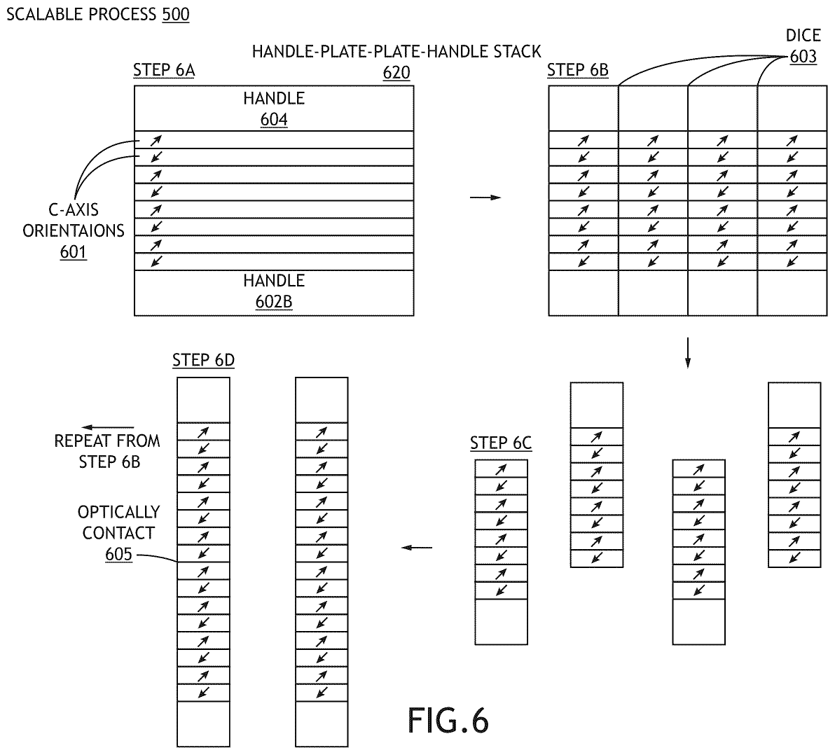

Referring to Steps 4E of FIG. 4, the process of Step 4A is repeated on an SBO block 401 with inverted c axis orientation 407 with respect to SBO block 400. In embodiments, SBO block 400 could be inverted and act as SBO block 401. The surface of SBO block 401 is polished to less than 1 nm rms surface roughness and cleaned. Ions are implanted 408 to form a damaged layer 419 of thickness t+Δt. Referring to Step 4F of FIG. 4, the surface of thin plate 412 is optically contact bonded 410 to the surface of SBO block 401. Referring to Step 4G of FIG. 4, SBO block 401 is etched or heated in order to cleave 411 it at the damaged layer 419 to generate a thin plate with c axis orientation opposite that of thin plate 412. Referring to Step 4H of FIG. 4, this generated thin plate is polished to thickness t and SBO block 401 is again polished. Thus, a handle-plate-plate stack 421 is generated. Using this stack as handle 404 in Step 4B, Steps 4A-4H can be repeated to generate a stack of many thin plates. In embodiments, the stack generated in FIG. 4 may be diced and stacked as described in the description of FIGS. 5 and 6 to create a many-layer stack of thin plates. In the description of FIG. 4, details related to polishing, bonding, cleaving, or annealing apply to all mentions of this process throughout the description.

In embodiments, different methods may be used to mitigate cracking in the thin SBO plate caused by strain and stress induced by a mismatch in thermal expansion coefficient of the handle material or by defects generation from ion implantation. These methods may include using SBO or sapphire, for example, as a handle to more closely match the thermal expansion coefficients. Another method may include an ion implantation step on the back side of the SBO bulk crystal to match the stress and strain on either side of the crystal and prevent bowing and cracking. To enhance optical bonding strength, a thin (approximately 1 nm) layer of silicon dioxide may be deposited, or a thicker layer may be deposited via plasma enhanced chemical vapor deposition under conditions to produce the appropriate stress and strain. After necessary annealing or polishing, this silicon dioxide layer can then be optically contact bonded to a handle which would not otherwise readily optically bond to SBO, or which needs heating in order to bond to SBO which could cause damage or cracking.

In embodiments, the method depicted in FIG. 4 may be applied to generate thin plates of LBO with the appropriate choice of orientation of the crystal axis.

FIG. 5 illustrates a simplified scalable method 500 for producing a large number of thin plates with alternating c-axes. The number of thin plates generated is 2N, where N is the number of dicing steps. Starting with the handle-plate-plate-handle stack 320 of FIG. 3, referring to Step 5A of FIG. 5, handle-plate-plate-handle stack 520 is diced 503 perpendicular to the plane of the contact surfaces of the thin plates. Referring to Step 5B of FIG. 5, the top handle of one diced stack is removed, and the bottom handle of the other diced stack is removed, and the exposed SBO surfaces are cleaned. Referring to Step 5C of FIG. 5, the exposed SBO surfaces are optically contacted 505 to generate a larger stack. This stack can then be diced according to Step 5A and iteratively performed to generate a stack of many-layered plates.

In embodiments, the handles on either side of the stack of thin plates are adhered to the plates using different methods. For example, one handle may be adhered to the adjacent thin plate with adhesive, and the other handle may be adhered with to the adjacent thin plate with optical contact bonding. In this embodiment, in Step SB of FIG. 5, one handle-plate-plate-handle stack may be submerged in a solvent to remove the handle adhered with adhesive while the optically contacted handle will remain in place. The other handle-plate-plate-handle stack may be submerged in an acid or base which selectively dissolves the optically contacted handle but leaves the plates and adhesive-contacted handles intact.

In embodiments, the method depicted in FIG. 5 may be performed with LBO with the appropriate choice of orientation of the crystal axis.

FIG. 6 illustrates a simplified scalable method 600 for producing a large number of thin plates with alternating c-axes. Referring to Step 6A of FIG. 6, starting with the handle-multi-plate stack 421 resulting from the method depicted in FIG. 4, a bottom handle 602B is adhered to the bottom thin-plate in the stack. Referring to Step 6B of FIG. 6, handle-multi-plate-handle stack 620 is diced 603 in one or multiple locations perpendicular to the plane of the contact surfaces of the thin plates.

Referring to Step 6C of FIG. 6, the top handle(s) of one or more diced stack is removed, and the bottom handle(s) of the other diced stack(s) is (are) removed, and the exposed SBO surfaces are cleaned. Referring to Step 6D of FIG. 6, the exposed SBO surfaces are optically contacted 605 to generate a stack with more layers. This stack can then be diced according to Step 6B and iteratively performed to generate a stack of many-layered plates.

In embodiments, the handles on either side of the stack of thin plates are adhered to the plates using different methods. For example, one handle may be adhered to the adjacent thin plate with adhesive, and the other handle may be adhered to the adjacent thin plate with optical contact bonding. In this embodiment, in Step 6C of FIG. 6, one handle-multi-plate-handle stack may be submerged in a solvent to remove the handle adhered with adhesive while the optically contacted handle will remain in place. The other handle-multi-plate-handle stack may be submerged in an acid or base which selectively dissolves the optically contacted handle but leaves the plates and adhesive-contacted handles intact.

In embodiments, the method depicted in FIG. 6 may be performed with LBO with the appropriate choice of orientation of the crystal axis.

FIG. 7 illustrates details of an embodiment in which nonlinear crystal 700 includes eight stacked SBO or LBO plates 735-1 to 735-8 configured to double the frequency of input light 701 having a frequency ωₓ. Although FIG. 7 illustrates nonlinear crystal 700 having a periodic structure including eight stacked SBO or LBO crystal plates 735-1 to 735-8, the total number of SBO or LBO plates may be as few as two, may be more than ten, or may be more than 100. There may be an odd or even number of plates. The thickness of each of the SBO or LBO plates 735-1 to 735-8 may be hundreds of nanometers to tens of microns. Concretely, the SBO or LBO plate thickness ∧ in a propagation direction of the light 701A inside a crystal plate is given by:

$$Λ = m {L}_{c} \qquad ( Equation 1 )$$

where m is an odd integer (e.g., 1, 3, 5, 7 . . . ) and L_{c} is a quasi-phase-matching (QPM) critical length

$${L}_{c} = \frac{π}{Δ k} \qquad ( Equation 2 )$$

where in the case of second harmonic generation, Δk is defined by

$$Δ k = k ( 2 {ω}_{x} ) - 2 k ( {ω}_{x} ) \qquad ( Equation 3 )$$

and in the case of sum-frequency generation, Δk is defined by

$$Δ k = k ( {w}_{3} ) - k ( {w}_{7} ) - k ( {w}_{2} ) \qquad ( Equation 4 )$$

where k(ω) is the wavevector of light of frequency ω in nonlinear crystal 700 given by

$$k ( ω ) = \frac{ω n ( ω )}{c} \qquad ( Equation 5 )$$

where n(ω) is the refractive index of the nonlinear crystal for the appropriate polarization at frequency ω and c is the velocity of light in vacuum. In the case of sum-frequency generation, ω₁+ω₂=ω₃. For doubling the frequency of input light 701 having a wavelength of 386.8 nm, the quasi-phase-matching critical length L_{c} for SBO is about 0.85 μm (e.g., such as a thickness between 0.8 μm and 0.9 μm). In LiB₃0₅, the critical length, L_{c}, is about 0.9 μm for type I quasi-phase matching (e.g., 386.8 nm light is polarized along the a crystallographic axis and 193.4 nm light is polarized along the c crystallographic axis) (e.g., such as a thickness between 0.85 μm and 0.95 μm). The critical length, L_{c}, is about 0.72 μm for type II quasi-phase matching (e.g., half of the 386.8 nm light is polarized along the a crystallographic axis and half is polarized along the c crystallographic axis, and 193.4 nm light is polarized along the c crystallographic axis) (e.g., such as a thickness between 0.7 μm and 0.8 μm). A reasonable m may be in a range from 1 to about 999 to achieve a convenient slab thickness for handling and processing. This exemplary QPM critical length for generating light having a wavelength of 193.4 nm by frequency-doubling light having a wavelength of 386.8 nm was calculated from the relevant refractive indices of SBO using the Sellmeier model published by P. Trabs, F. Noack, A. S. Aleksandrovsky, A. I. Zaitsev, N. V. Radionov, and V. Petrov, in “Spectral fringes in non-phase-matched SHG and refinement of dispersion relations in the VUV”, Opt. Express 23, 10091 (2015), and from the relevant refractive indices of LBO using the Sellmeier model published by K. Kato, in “Temperature-tuned 90° phase-matching properties of LiB₃0₅”, IEEE J. Quant. Electr. 30 (12), 2950-2952 (1994). The accuracy of these Sellmeier models is uncertain. Furthermore, varying levels of impurities in an SBO or LBO crystal or the presence of defects within a crystal may slightly change values of the refractive indices of that crystal. One skilled in the relevant arts would understand how to calculate the QPM critical length using the above equations for specific input and output frequencies given accurate refractive indices of the crystal.

Referring to FIG. 7, input light 701 of frequency ωₓ, which can be comprised of one or more wavelengths depending on whether second harmonic generation (where ωₓ comprises a single wavelength) or sum frequency generation (where ωₓ comprises ω₁ and ω₂) is desired, is incident on input surface 735-IN of nonlinear crystal 700. The SBO or LBO plates 735-1 to 735-8 are optically contacted on top of one another so that input surface 735-IN and output surface 735-OUT are oriented at an angle θ_{B} relative to the input light 701 of frequency ωₓ. Since the precise angle is not critical to reflection losses, small adjustments can be made to the orientation of nonlinear crystal 700 (e.g., small adjustments to incident angle θ) to adjust the path length of the light A in the SBO or LBO plates in order to more precisely achieve QPM when the thickness of the plates is not precisely the intended thickness due to manufacturing variability. Additionally, the temperature of the stack of slabs can be tuned, thereby shifting the temperature-dependent index of refraction and correcting thickness variation-dependent issues. The light ω_{OUT} 703 exiting the stack of SBO or LBO plates comprises the second harmonic of the input light at a frequency of 2ωdx in the case of second harmonic generation and the sum of the two fundamental frequencies ω₃ in the case of sum frequency generation, and unconsumed input light at a frequency or frequencies of ωₓ. The crystal plates may be optically contacted, minimizing reflection or scattering losses between each plate. The sections of the crystal may be continuous and therefore not have reflection or scattering losses at the interfaces, as the indices will be matched.

In embodiments, angle θ_{B} in FIG. 7 is approximately the Brewster's angle so as to minimize reflection losses without using an antireflection coating. Brewster's angle in SBO is approximately equal to 60.3° with respect to the surface normal N for wavelengths near 386 nm polarized parallel to the c axis of an SBO crystal (while propagating inside the crystal) and is approximately equal to 61.9° with respect to the surface normal N for wavelengths near 193 nm with the same polarization direction inside the crystal. The polarization direction of the input light 701 is illustrated by the dashed-line-arrow 702. Reflection losses are low at any angle within a few degrees (such as within ±2°) of Brewster's angle, so there will be very low reflection losses for both the input light and the output light for any incident angle near 61°.

In embodiments, input light 701 of frequency ωₓ can be prism coupled into the stack. In one such embodiment, SBO or LBO material can be adhered at either end of the stack and be cut to allow light to couple in at the Brewster's angle and then travel through unpoled material before reaching poled material.

In embodiments, an antireflection coating for input light 701 and output light 703 can be applied to input surface 735-IN and/or output surface 735-OUT to minimize reflections of the light frequencies involved in the conversion.

Referring to FIG. 7, in order to create a periodic structure for quasi-phase matching for the crystal 700, SBO or LBO plates 735-1 to 735-8 are placed with one rotated relative to the other such that their corresponding c crystal axes are inverted with respect to each other as shown in the two insets of FIG. 7. The surface normal N of the SBO plate of thickness ∧ (where ∧ is the spacing between poles in the crystal) and the propagation direction of light 701A inside the SBO or LBO plate are shown in the two insets. This physical arrangement of the crystal plates allows for quasi-phase matching.

In a preferred embodiment, the crystal axes of SBO plates 735-1 to 735-8 are oriented such that light 701 propagating inside the SBO plates propagates substantially perpendicular to the c-axis with a polarization direction (electric field direction) of light 701A substantially parallel to the c-axis. This utilizes the largest nonlinear coefficient in SBO, d₃₃, and hence maximizes conversion efficiency.

In an alternative preferred embodiment utilizing LBO, there is an additional constraint for LBO in that to access the largest nonlinear coefficient, d₃₁, the fundamental polarization direction of light should be substantially parallel to the a-axis for type I phase matching in plates 735-1 to 735-8. While type II phase matching is possible, type I phase matching is preferred. For type I phase matching utilizing the d₃₁ nonlinear coefficient, the fundamental light is polarized parallel to the a-crystallographic axis and produces a second harmonic polarized parallel to the c-crystallographic axis. The phase mismatch caused by the different index of the fundamental(s) and higher harmonic is compensated by alternatively flipping the direction of the c-crystal axis of the material by 180 degrees, so that the phase difference between the harmonics is alleviated by the different sign of the nonlinear coefficient. Therefore, the LBO crystal plates must be cut perpendicular to the b-axis in the c-a plane. The SBO crystal, as the fundamental and generated frequencies both have polarizations substantially parallel to the c-axis, can be cut perpendicular to the a-axis in the c-b plane, perpendicular to the b-axis in the a-c plane, or at any angle that includes the c-axis in the plane. For example, in one embodiment as depicted in FIG. 7, the crystal axes of SBO plate 735-1 may be oriented such that the light 701A direction of propagation is substantially parallel to the a-axis of the SBO crystal. In an alternative embodiment, the crystal axes may be oriented such that light 701A propagates parallel to the b-axis, or at some angle within an a-b plane of the crystal. In other words, the crystal axes depicted in the two insets in FIG. 7 may be rotated about the c-axis. If the input surface of SBO plate 735-IN is oriented at Brewster's angle with respect to input light 701, then the direction of propagation of the light 701A within plate 735-2 will be approximately 29.7° relative to surface normal N, for a fundamental wavelength of approximately 386 nm.

Table 1 includes a table of exemplary room-temperature coherence lengths required by quasi-phase matched SBO or LBO crystals to generate wavelengths produced by the laser assemblies 200-0 and 200A of FIGS. 1 and 2. The approximate generated wavelengths of the laser output light Lout and 239 in Table 1 are in the ranges of 125 nm to 140 nm (e.g., approximately 133 nm), 147 nm to 155 nm (e.g., approximately 152 nm), 170 nm to 180 nm (e.g., approximately 177 nm), and 190 nm to 195 nm (e.g., approximately 193 nm), in accordance with exemplary embodiments of the present disclosure. For the fundamental laser type, an exemplary fundamental wavelength is shown, along with the wavelengths corresponding to the harmonics. The exact wavelength of a fundamental laser depends on many factors including the exact composition of the lasing medium, the operating temperature of the lasing medium, and the design of the optical cavity. Two lasers using the same laser line of a given lasing medium may operate at wavelengths that differ by a few tenths of 1 nm or a few nm due to the aforementioned and other factors. One skilled in the appropriate arts would understand how to choose the appropriate first and second fundamental wavelengths in order to generate the desired output wavelength from any fundamental wavelength close to those listed in the table. Similarly, if the desired output wavelength differs from 133 nm by a few nm, 152 nm by a few nm, from 177 nm by a few nm, or from 193 nm by a few nm, the desired output wavelength can also be achieved by an appropriate adjustment of the wavelength for the first or the second fundamental wavelength.

TABLE I

| | Higher | | LiB₃O₅ Coherence |
|---|---|---|---|
| Fundamental | harmonic | SrB₄0₇ | length (Type I |
| wavelength(s) | wavelength | Coherence | phase-matching) |
| (ωₓ) | (ω_{OUT}) | length (L_{c}) | (L_{c}) |
| 386 nm | 193 nm | 843 nm | 900 nm |
| 355 nm | 177 nm | 598 nm | 621 nm |
| 532 nm, 266 nm | 177 nm | 655 nm | 690 nm |
| 532 nm, 213 nm | 152 nm | 338 nm | |
| 355 nm, 266 nm | 152 nm | 297 nm | |
| 266 nm | 133 nm | 134 nm | |

Although the present invention is described herein using various fundamental wavelengths that facilitate generating laser output light at a desired wavelength between approximately 120-200 nm, other wavelengths within a few or a few tens of nanometers of this desired wavelength can be generated by changing the wavelength of the first fundamental laser (laser 200A). Unless otherwise specified in the appended claims, such lasers and systems utilizing such lasers are considered within the scope of this invention.

Periodically poled SBO and LBO crystals are not commercially available. In particular, there is no prior art for growing periodically poled crystals with high purity, high damage threshold, high nonlinear coefficient, and high transparency in the sub-200 nm region from a periodically poled seed.

Lasers with a wavelength in the sub-200 nm are not commercially available at sufficient power level or are unreliable or expensive to operate. In particular, there is no prior art other than excimer lasers for generating IW of light power or more in a wavelength range between approximately 120 nm and 200 nm. The embodiments of the present invention generate a wavelength between 120-200 nm, therefore provide better sensitivity for detecting small particles and defects than longer wavelengths. The lasers of the present invention do not use toxic or corrosive gasses, and are therefore easier and less expensive to operate and maintain.

One skilled in the appropriate arts will readily appreciate that there are many possible applications of the inventive laser crystals described herein in addition to their use in semiconductor inspection and metrology. For example, a laser operating at a wavelength close to 193.4 nm can be used in a lithography system configured to expose patterns into photoresist coated on a substrate such as a semiconductor wafer. In another example, a laser operating at a wavelength between about 120 nm and 200 nm may be used in a system configured to cut or ablate biological tissue. The lasers described herein can be configured to generate very short pulses at the output wavelength, which can enable preferential removal of material by ablation instead of by heating thereby causing less damage to surrounding material. For example, such lasers may be used in laser eye surgery or laser vision correction.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The description is presented to enable one of ordinary skill in the art to make and use the disclosure as provided in the context of a particular application and its requirements. As used herein, directional terms such as “top,” “bottom,” “over,” “under,” “upper,” “upward,” “lower,” “down,” and “downward” are intended to provide relative positions for purposes of description and are not intended to designate an absolute frame of reference. Various modifications to the preferred embodiment will be apparent to those with skill in the art, and the general principles defined herein may be applied to other embodiments. Therefore, the present disclosure is not intended to be limited to the particular embodiments shown and described but is to be accorded the widest scope consistent with the principles and novel features herein disclosed.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A method for creating a periodically poled nonlinear crystal comprising:
implanting ions of a predetermined energy into a first nonlinear crystal at a uniform depth to generate a damaged or amorphous layer, wherein the nonlinear crystal comprises at least one of strontium tetraborate (SBO) or lithium triborate (LBO);
adhering a handle comprising a solid material to the surface of the first nonlinear crystal;
heating or chemically etching the first nonlinear crystal in order to cleave the first nonlinear crystal at the damaged or amorphous layer into a first thin plate attached to the handle and a larger crystal; and
polishing the first thin plate to a predetermined thickness to form a handle-plate (HP) stack.

2. The method of claim 1, wherein the ions comprise one or more gases, wherein the one or more gases comprises at least one of a single gas or a mixture of gases.

3. The method of claim 2, wherein the one or more gases includes at least one of helium or oxygen.

4. The method of claim 1, wherein the HP stack is diced into two separate HP stacks perpendicular to the plane between the handle and the first thin plate.

5. The method of claim 1, wherein two HP stacks are optically contacted to one another along an exposed face of the polished thin plate such that a first crystal axis of the first crystal plate is inverted with respect to a second crystal axis of the second crystal plate to create a handle-plate-plate-handle (HPPH) stack comprising a first handle, two thin crystal plates, and a second handle.

6. The method of claim 5, wherein the HPPH stack is diced to form two or more HPPH stacks;
wherein a first handle of at least one HPPH stack is removed to form a plate-plate-handle (PPH) stack comprising two thin plates and a second handle;
wherein a second handle of at least one different HPPH stack is removed to form a handle-plate-plate (HPP) stack comprising a first handle and two thin plates; and
wherein an exposed thin crystal plate of a PPH stack is optically contacted to an exposed thin plate of the HPP stack to create a handle-multiple plates-handle (HMPH) stack comprising a handle, multiple thin plates, and a handle, wherein the multiple thin plates have alternating c-axis crystal orientations.

7. The method of claim 6, wherein the process of dicing, removing handles, and optically contacting an HMPH stack is repeated iteratively to increase the number of thin plates in the HMPH stack.

8. The method of claim 1, further comprising:
implanting ions at a predetermined energy into a second nonlinear crystal, with a crystal axis inverted with respect to a crystal axis of the first nonlinear crystal, at a uniform depth to generate a damaged or amorphous layer, wherein the second nonlinear crystal comprises at least one of strontium tetraborate (SBO) or lithium triborate (LBO);
optically contacting the face of the polished thin plate of the stack to the surface of the second nonlinear crystal;
heating or chemically etching the second nonlinear crystal in order to cleave the second nonlinear crystal at the damaged or amorphous layer into an additional thin plate attached to the stack; and
polishing the additional second thin plate to a predetermined thickness in order to form an HPP stack having a handle and two thin plates of alternating c-axis orientation.

9. The method of claim 8, wherein the process of creating thin plates of alternating crystal axis orientations from the first and second nonlinear crystal is repeated to create a handle-multiple plate (HMP) stack including a handle and a predetermined number of multiple thin plates.

10. The method of claim 9, wherein a second handle is adhered to an exposed thin plate of the HMP stack to form a HMPH stack including a first handle, multiple thin plates, and a second handle.

11. The method of claim 10, wherein the HMPH stack is diced to create two or more HMPH stacks;
wherein the first handle of at least one HMPH stack is removed to form a multiple plate-handle (MPH) stack including multiple thin plates and the second handle;
wherein the second handle of at least one different HMPH stack is removed to form an HMP stack comprising the first handle and multiple thin plates; and
wherein the exposed thin crystal plate of the MPH stack is optically contacted to the exposed thin plate of the HMP stack to create an HMPH stack including a handle, multiple thin plates, and a handle, wherein the multiple thin plates have alternating c-axis crystal orientations.

12. The method of claim 1, wherein the handle comprises at least one of strontium tetraborate (SBO), lithium triborate (LBO), calcium fluoride, magnesium fluoride, lithium fluoride, silicon dioxide, or sapphire.

13. The method of claim 1, wherein the method of adhesion of the handle to the nonlinear crystal comprises optically contacting with least one of pressure bonding, heating, chemically activating, or plasma activating.

14. A nonlinear crystal grown using as a seed the periodically poled crystal created using the method of claim 1.

15. The method of claim 1, wherein a crystal plate thickness and orientation of a plurality of crystal plates are configured to achieve phase matching to achieve wavelength of 193 nm.

16. The method of claim 1, wherein a crystal plate thickness and orientation of a plurality of crystal plates are configured to achieve phase matching to generate a wavelength in the range of 172-178 nm.

17. The method of claim 1, wherein a crystal plate thickness and orientation of a plurality of crystal plates are configured to achieve phase matching to generate a wavelength in the range of 147-153 nm.

18. The method of claim 1, wherein a crystal plate thickness and orientation of plurality of crystal plates are configured to achieve phase matching to generate a wavelength in the range of 129-134 nm.

19. The method of claim 1, wherein a crystal plate thickness is an odd multiple of at least one of 700-860 nm, 430-620 nm, 510-690 nm, 200-380 nm, 200-320 nm, or 80-175 nm, wherein a c crystal axis of the first crystal plate is inverted with respect to a c crystal axis of the second crystal plate.

20. The method of claim 1, wherein a crystal plate thickness is an odd multiple of at least one of 860-940 nm, 580-660 nm, and 650-730 nm, wherein a c crystal axis of the first crystal plate is inverted with respect to a c crystal axis of the second crystal plate.

21. An optical system comprising:
an illumination source configured to generate illumination between 120 to 200 nm;
an optical sub-system configured to direct the illumination from the illumination source onto a sample, wherein the illumination source comprises:
a first fundamental laser configured to generate a fundamental laser beam having a corresponding fundamental frequency and a fundamental wavelength between 720 nm and 800 nm; and
two or more frequency doubling stages, the two or more frequency doubling stages including at least an intermediate frequency doubling stage and a final frequency doubling stage, the intermediate frequency doubling stage is configured to receive the first fundamental frequency and generate a second harmonic light having a second harmonic frequency, the final frequency doubling stage is configured to generate laser output light from the second harmonic light, the final frequency doubling stage includes the nonlinear crystal configured to double a frequency of the second harmonic light,
wherein the nonlinear crystal includes a plurality of crystal plates disposed in a stacked configuration such that each first crystal plate is adjacent to at least one second crystal plate, the plurality of crystal plates includes at least one of one or more strontium tetraborate (SBO) crystal plates or one or more lithium triborate (LBO) crystal plates, and
wherein the plurality of crystal plates are cooperatively configured to form a periodic structure that achieves quasi-phase-matching (QPM) of the first fundamental frequency and the second harmonic frequency.
